(19) United States
(12) Patent Application Publication
(10) Pub. No.: US 2008/0080433 A1
(43) Pub. Date: Apr. 3, 2008

(54) Apparatus and method providing communication channels with wide and narrow bandwidths within a shared frequency band

(76) Inventors: Daryl Cromer, Cary, NC (US); Philip John Jakes, Durham, NC (US); Howard Jeffrey Locker, Cary, NC (US); Raymond Gary Octaviano, Marietta, GA (US)

Correspondence Address: Ronald V. Davidge;Suite 219, 9900 Stirling Road, Cooper City, FL, 33024, US

(21) Appl. No.: 11/528,815

(22) Filed: Sep. 28, 2006

(51) Int. Cl. H04Q 7/24

(52) U.S. Cl. 370/338

(57) ABSTRACT

Communications are provided for wide-channel and narrow-channel wireless devices within a common area over a number of channels within a common radio frequency band. Since communications using a wide-channel wireless signal interfere with at least two channels over which communications using narrow-channel wireless signals can occur, wide-channel communications are established only when it is determined that a wide-channel wireless device is present within the common area.

### BACKGROUND OF THE INVENTION

1. Field of the Invention

This invention relates to providing wireless communications through access points communicating over shared channels with different bandwidths, and, more particularly, to providing communications in accordance with IEEE 802.11n standards with a 40 MHz bandwidth over channels additionally used to provide communications in accordance with IEEE 802.11b and 802.11g standards with a 22 MHz bandwidth.

2. Summary of the Background Art

Access points are widely used to provide wireless devices having wireless capabilities, such as laptop computers including subsystems operating according to various levels of the IEEE 802.11 standard for wireless communication, with a capability to transmit to, and receive data from, a wired network, such as the Internet or a wired LAN connected to the access point, with a number of mobile wireless systems being connected to the wired network through a radio transmitter and receiver within the access point. Such a connection can be made when the mobile wireless device enters the range of the access point. For a message to be transmitted to or from a wireless device, the wireless device must be associated with an access point.

An access point transmits a series of beacon frames that can be recognized by a wireless device entering the range of the access point. The process of association, which synchronizes the wireless device and the access point for communication over a radio link, begins with the wireless device scanning to determine which access points can be reached from its location. A wireless device may scan using a passive scanning process by simply monitoring the beacon frames transmitted by access points. Alternately, the wireless device may use an active scanning process by transmitting probe frames, causing an access point close enough to receive the probe frames to transmit response frames if certain criteria are met by the probe frames.

Wireless technology is rapidly growing, with new standards emerging to offer additional bandwidth and new capabilities for customers. The electronics industry is rapidly adopting such new standards, to be incorporated in new products. An example of product transitions caused by the adoption of new standards is found in the wireless capabilities being provided within laptop computers, which have been built to 802.11b standards in 2003, to 802.11b and 802.11g standards in 2004, and to 802.11a, 802.11b, and 802.11g standards in 2005. Soon, operation according to 802.11n standards will also be included.

For suppliers of computer systems, this process has been generally straightforward, with the technologies being backward-compatible, so that, for example, a system designed to operate according to 802.11g standards can communicate through an access point operating according to 802.11b standards. This kind of backward-compatibility has made it possible to provide increasing capabilities while protecting the investments of individuals and organizations in computers and network systems. For example, while the present base of computer systems and available networks today have been mostly been built to 802.11b standards, new computer systems are being built to support 802.11g and 802.11a standards as well. It is expected that, in the future, access points will be upgraded to support communication according to the newer standards as well. What is needed is needed is a method for providing maximum network bandwidth as computer system users migrate to present a mixture of systems having adapters built to 802.11a, 802.11b, 802.11g, and 802.11n standards.

For an organization providing an access point, important considerations are maximizing capabilities by maximizing the available bandwidth and minimizing costs by minimizing the number of antennas required and by minimizing the number of transmit/receive chains required to carry signals to and from the access point to the network. The current proposed 802.11n standard defines 40-MHz wide channels.

It is further believed that clients, such as laptop computers and adapter cards for use therein, having 802.11 capability will rapidly appear, but that changes in the infrastructure of access points will occur more slowly. At present, the use of 802.11b technology is dominate, with 802.11g and 802.11a being used as overlay technologies. Since it is believed that 802.11n will quickly be adopted as another overlay technology, what is needed is a way to alleviate a dramatic reduction in the capability of an access point area to handle the needs of 802.11a, 802.11b, and 802.11g users within the area.

A problem concerning the capacity of an access point area to handle communication with 802.11a, 802.11b, and 802.11g users within the area arises from the fact that a 40-MHz wide 802.11n channel eliminates two 802.11b or 802.11g channels, which are then reduced to one non-overlapping channel. For example, if an access point providing two 802.11b channels or two 802.11g channels is replaced with an access point providing one 802.11n channel, the capability of the access point to handle communication with 802.11a, 802.11b, and 802.11g users is cut in half. Thus, what is needed is a method allowing an access point to provide 802.11n communication with early adopters of this technology while minimizing the impact on communication with the users of 802.11a, 802.11b, and 802.11g technologies.

In more general terms, what is needed is an efficient method for allowing narrow-channel wireless devices, such as wireless devices operating in 22 MHz wide frequency ranges according to the 802.11b and 802.11g standards, and wide-channel wireless devices, such as a wireless devices operating in a 40-MHz wide frequency range according to an 802.11n standard, to operate in an access point environment, under conditions in which operation of the narrow-channel wireless devices is not adversely affected when no wide-channel wireless device is present.

### SUMMARY OF THE INVENTION

According to one aspect of the invention, a method is provided for providing communications with narrow-channel wireless devices and with wide-channel wireless devices within a common area over a plurality of channels within a common radio frequency band. The method includes:

a) determining whether at least one wide-channel wireless device is present within the common area;

b) establishing communications using a wide-channel wireless signal with at least one wide-channel wireless device in response to determining that at lease one wide-channel wiereless device is present within the common area;

c) determining that communications have ended with each wide-channel wireless device; and

d) stopping transmission of the wide-channel wireless signal in response to a determination that communications have ended with each wide-channel wireless device.

In a first version of the invention, step a) comprises determining whether wide-channel probe frames are being received from at least one wide-channel wireless device, while step b) comprises transmitting wide-channel response frames in response to receiving the wide-channel probe frames, and while step d) comprises stopping transmission of the wide-channel wireless signal without continuing to transmit wide-channel probe frames. Step b) may additionally include beginning the transmission of wide-channel beacon frames in response to receiving the wide-channel probe frames with step d) including, for a predetermined period, determining that wide-and probe frames are not being received and that wide-channel and that a response to wide-channel beacon frames has not been received, before stopping transmission of the wide-channel beacon frames. Step b) may additionally include establishing communications using a wide-channel wireless signal in response to receiving a response to the wide-channel probe frames from a wide-channel wireless device.

In a second version of the invention, step a) comprises receiving a request for wide-channel communications within a narrow-channel access point, with the request for wide-channel communications being transmitted to a narrow-channel access point with a narrow-channel wireless signal, and with the request then being transmitted along a LAN (local area network) from the narrow-channel access point to a wide-channel access point. The wide-channel access point may then respond by transmitting a response to the message along the LAN to the narrow-channel access point, with the narrow-channel access point transmitting the response to the wide-channel wireless device using a narrow-channel signal. Alternately, the wide-channel access device may begin transmitting wide-channel beacon frames in response to receiving the request for wide-channel communications.

According to another aspect of the invention, a wireless device is provided, comprising a transceiver and a processor. The transceiver receives and transmits data using a wide-channel wireless signal and a narrow-channel wireless signal. The processor means is programmed to provide a method comprising transmitting a request for wide-channel communications using the narrow-channel wireless signal.

The request for wide-channel communications may comprise transmitting probe frames, with wide-channel communications then being established in response to receiving a response to the probe frames. Alternately, an association may be formed with a narrow-channel access point, which then transmits a request for wide-channel communications along a LAN to a wide-channel access point also connected to the LAN.

### BRIEF DESCRIPTION OF THE FIGURES

FIG. 1 is a pictographic view of an area including three narrow-channel access points and an access point operating in accordance with the invention;

FIG. 2 is a table of frequencies used for communication within the area of FIG. 1;

FIG. 3 is a table of frequencies used for communication within an area including two narrow-channel access points and an access point operating in accordance with the invention;

FIG. 4 is a table of frequencies used for communication within an area including one narrow-channel access point and an access point operating in accordance with the invention;

FIG. 5 is a flow chart showing processes occurring in accordance with the invention within the area of FIG. 1;

FIG. 6 is a block diagram of a wide-channel wireless device within the area of FIG. 1;

FIG. 7 is a block diagram of a wide-channel access point within the area of FIG. 1;

FIG. 8 is a flow chart showing processes occurring within a wide-channel access point of FIG. 1 in accordance with a first embodiment of the invention;

FIG. 9 is a flow chart showing processes occurring within the wide-channel access point of FIG. 1 in accordance with a second embodiment of the invention;

FIG. 10 is a flow chart, including an upper portion, indicated as FIG. 10A, and a lower portion, indicated as FIG. 10B, and showing processes occurring within a wide-channel wireless device of FIG. 1 in accordance with a third embodiment of the invention;

FIG. 11 is a flow chart showing processes occurring within the wide-channel access point of FIG. 1 in accordance with the third embodiment of the invention;

FIG. 12 is a flow chart, including an upper portion, indicated as FIG. 10A, and a lower portion, indicated as FIG. 12B, and showing process steps occurring within the wide-channel wireless device of FIG. 1 in accordance with a fourth embodiment of the invention; and

FIG. 13 is a flow chart showing processes occurring within the wide-channel access point of FIG. 1 in accordance with the fourth embodiment of the invention.

### DETAILED DESCRIPTION OF THE INVENTION

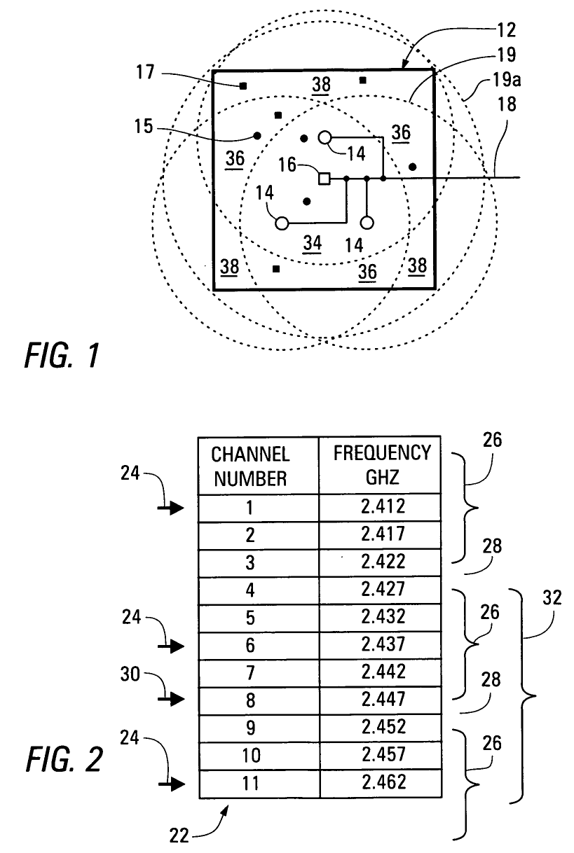

FIG. 1 is a pictographic plan view of a common area 12 including three narrow-channel access points 14 of conventional types, configured for communication with narrow-channel wireless devices 15, such as 802.11b and 802.11g wireless devices communicating over channels having bandwidths of 22 MHz, and a single wide-channel access point 16 operating in accordance with the invention to communicate with wide-channel wireless devices 17, such as 802.11n wireless devices communicating over a channel having a 40 MHz bandwidth. The access points 14, 16 are attached to a wired LAN 18 (local area network), which may be additionally connected to the Internet, providing access to the Internet to wireless devices 15, 17 within the common area 12, which is understood to be a “common” area merely because of the overlapping nature of the ranges of the access points 14, 16. Alternately, the LAN 18 may be part of a corporate LAN, to which the wireless devices 15, 17 are connected through the access points 14, 16. The area 12 may be a large room, such as a waiting room within an airport, or a number of offices in a corporate setting. The common area 12 may be defined by structural objects, such as walls, or by the range of the various wireless devices and access points included. In the example of FIG. 1, three narrow-channel access points 14 are provided so that access to wireless communication is provided throughout the area 12, which is too large to cover effectively with a single narrow-channel access point 14, and additionally to provide a capacity for communicating with a sufficiently large number of narrow-channel wireless devices 15, such as 802.11b and 802.11g wireless devices, within the common area 12. For example, a single narrow-channel access point 14 can be configured to communicate with six 802.11b wireless devices or eleven 802.11g wireless devices. Each of the narrow-channel access points 14 provides communication within a range 18 including a portion of the common area 12, with the three ranges 18 overlapping to provide communication within the entire area 12. The wide-channel access point 16 uses an improved antenna technology to provide communication with 802.11n wireless devices 17 within the entire area 12, having a range 19a encompassing the area 12.

FIG. 2 is a table of frequencies used for wireless communication within the common area 12. In North America, eleven channels 22 are provided for communication with 802.11b, 802.11g, and 802.11n wireless devices 15 within the 2.4 GHz Industrial, Scientific, and Medical (ISM) radio band. However, communication with the 802.11b and 80211g wireless devices 15 require 22 MHz of bandwidth and communication with an 802.11n wireless device requires 40 MHz of bandwidth. Thus, adjacent channels, such as channels 1 and 2, cannot be used within the same space because the use of overlapping frequency spectra would result in interference between the communications occurring on the adjacent channels. However, there is enough frequency range within the ISM radio band to allow communication on three spaced-apart channels within the same area, such as the channels 1, 6, and 11, which are indicated in the figure by arrows 24 as being used for communication within the common area 12, with one of the narrow-channel access points 14 communicating on channel 1, while the other two narrow-channel access points 14 communicate on channels 6 and 11, respectively. Communication at each of these channels use a bandwidth of 22 MHz, indicated as frequency bands 26, with gaps 28 between these frequency bands 26 providing an assurance that interference does not occur between communication occurring in different frequency bands 26.

In the example of FIG. 2, the wide-channel access point 16 provides communication on channel 8, as indicated by arrow 30, having a 40 MHz bandwidth covering a frequency band 32. Because this frequency band 32 overlaps both of the frequency bands 26 associated with channels 6 and 11, the narrow-channel access points 14 using channels 6 and 11 cannot be used for communication within the common area 12 during operation of the wide-channel access point 16. It is noted that this situation cannot be improved by choosing another channel for the wide-channel access point 16; depending on the channel chosen, interference will occur between the wide-channel access point 16 and two or all three of the narrow-channel access points 14.

Within a central area 34 of the common area 12, a narrow-channel wireless device 15 can communicate with any one of the three narrow-channel access points 14 when the wide-channel access point 16 is not communicating. However, when the additional narrow-channel access point 16 is communicating, interference conditions between channel 8, which is used for communication with wide-channel wireless devices 17, and channels 6 and 11 restrict communication with the narrow-channel access points 14 using these channels 6 and 11, so that only communication with the single narrow-channel access point 14 using channel 1 can occur. Thus, the elimination of the ability of two of the three narrow-channel access points 14 to provide communication restricts the number of narrow-channel wireless devices 15 that can communicate with these narrow-channel access points 14. For example, when the wide-channel access point 16 is communicating, the single narrow-channel access point 14 can only communicate with only six 802.11b wireless devices or eleven 802.11g wireless devices instead of the eighteen 802.11b wireless devices or thirty-three 802.11g wireless devices with which all three narrow-channel access points 16 can communicate when the wide-channel access point 16 is not communicating.

Within other areas 36 of the common area 12, the ranges 19 of two of the narrow-channel access points 14 overlap one another but not the range 19 of the other narrow-channel access point 14. In such areas 36, a narrow-channel wireless device 15 can communicate with two of the narrow-channel access points 14 while the wide-channel access point 16 is not communicating. However, when the wide-channel access point 16 is communicating, communication is possible only with the narrow-channel access point 14 using channel 1, due to interference between channel 8 and the remaining channels 6 and 11 used by the other two access points 14. Thus, in the area 36 within the range of the narrow-channel access point 14 using channel 1 and one of the other narrow-channel access points 14, the number of narrow-channel access points 14 that can be accessed for communication is cut in half, from two access points 14 to only one. Furthermore, in the area 36 included only in the overlapping ranges of the narrow-channel access points 14 using channels 6 and 11, no communication can be established with one of the narrow-channel access points 14.

One or more other areas 38 within the area 10 lie within the range 18 of only one of the narrow-channel access points 16. In such an area 38, if communication can be achieved with the narrow-channel access point 16 using channel 1, such communication is not effected by the operation of the wide-channel access point 16. Otherwise, communication cannot be achieved with any of the narrow-channel access points 14 when the wide-channel access point 16 is communicating.

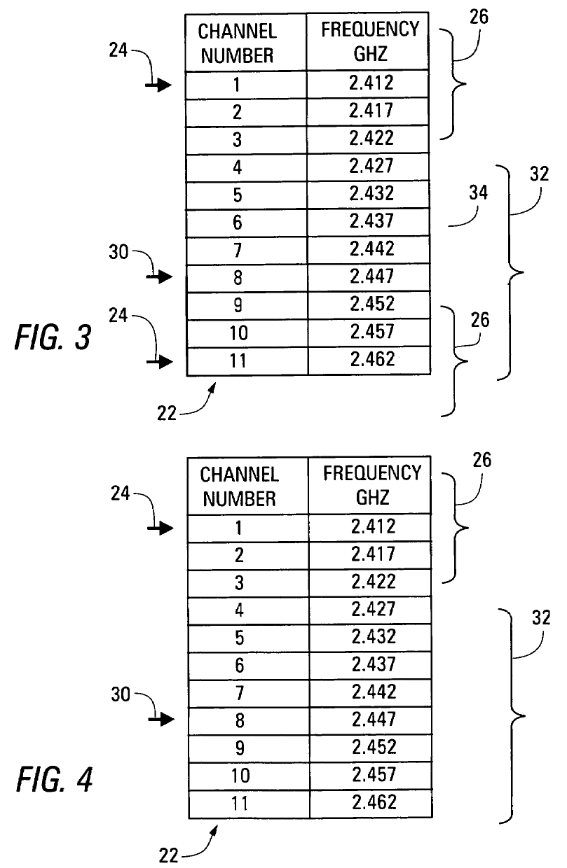

FIG. 3 is a table of frequencies used for communication within an area including two narrow-channel access points 14, operating on channels 1 and 11, respectively, as indicated by arrows 24, and a wide-channel access point 16 operating in accordance with the invention, on channel 8, as indicated by arrow 30. While the gap 34 between the frequency bands 26 used for communication with the narrow-channel access points 14 is larger than the gaps 28 shown in FIG. 2, this gap 34 is not large enough to include the frequency band 32 used for communication with the wide-channel access point 16. Therefore, while communication with the narrow-channel access point 14 operating at channel 1 is not affected, communication is achieved with the narrow-channel access point 14 operating on channel 11 can occur only when the wide-channel access point 16 is not communicating. When the wide-channel access point 16 is communicating, in an area within the range of both narrow-channel access points 14, only one of these narrow-channel access points 14 can be used. Additionally, when the wide-channel access point 16 is communication, in an area within the range of only one of the narrow-channel access points 14, communication can be achieved with the single narrow-channel access point 14 if it is using channel 1 but not if it is using channel 11.

FIG. 4 is a table of frequencies used for communication within an area including a single narrow-channel access point 14, operating on channel 1, as indicated by arrow 23, and a wide-channel access point 16, operating on channel 8 in accordance with the invention. With only one narrow-channel access point 14, it is possible to choose channels that separate the frequency range 28 of the narrow-channel access point 14 from the frequency range 32 of the wide-channel access point 16, so that communication with the narrow-channel access point 14 is not affected by the wide-channel access point 16.

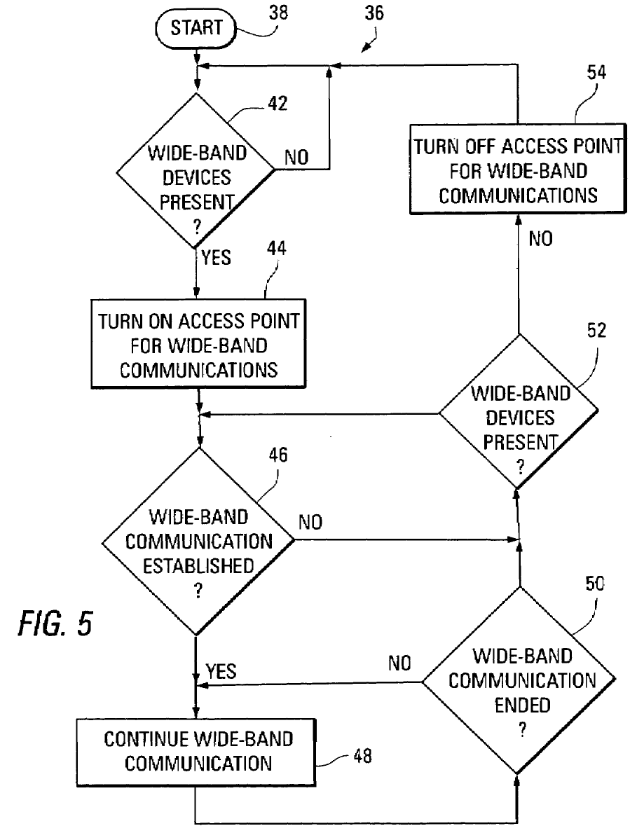

Thus, except under the conditions described above in reference to FIG. 4, the capacity of a system of narrow-channel access points 14 to communicate with narrow-channel wireless devices 15 is severely limited by the additional presence of a wide-channel access point 16 communicating with wide-channel wireless devices 17. Therefore, in accordance with the invention, a method 36, shown in FIG. 5, is provided for turning on the wide-channel access point 16 for wide-channel communication only in response to determining that a wide-channel wireless device 17 is present within the common area 12. After starting in step 38, the method 36 proceeds to step 42 to determine whether one or more wide-channel wireless devices 17 is present within the common area 12. If it is present, the method 36 proceeds from step 42 to step 44, in which the wide-channel access point 16 is turned on for wide-channel communication. If it is determined in step 40 that a wide-channel wireless device 17 is not present within the common area 12, the method 36 returns to step 40, so that the determination of this step 40 is made on a periodic basis, with communications through the narrow-channel access points 14 being unaffected by the operation of the wide-channel access point 16 until the presence of a wide-channel wireless device is detected.

After the wide-channel access point 16 is turned on in step 44 for wide-channel communication, a further determination is made in step 46 of whether such communication has been established. If it has, wide-channel communication is continued in step 48 until an additional determination is made in step 50 that the wide-channel communication has ended. (In this context wide-channel communication is understood to include communication with one wide-channel wireless device 17 or with a number of such wireless devices 17.) If it is determined in step 50 that all such wide-channel communication has ended, the method 36 proceeds to step 52 in which another determination is made of whether wide-channel wireless devices 17 are present. If they are, the method 36 begins a process of periodically determining, in step 46, whether wide-channel communication has been established, and if it has not been established, of then determining, in step 52 whether wide-channel wireless devices 17 are present within the common area 12. If it is determined in step 52 that wide-channel wireless devices 17 are not present, the wide-channel access point 16 is turned off in step 54, with the method 36 then returning to step 42 to begin a periodic determination of whether wide-channel wireless devices 17 have become present.

This method 36 is different from conventional operation with an access point in that the access point 16 operates in a passive mode until the presence of a wide-channel wireless device 17 is detected. In conventional operation, an access point operates in an active mode whenever it is turned on, providing periodic beacon signals that are received by a wireless device within the range of the access point, with the wireless device, upon receiving the beacon signals, beginning the process of association with the access point to establish communication.

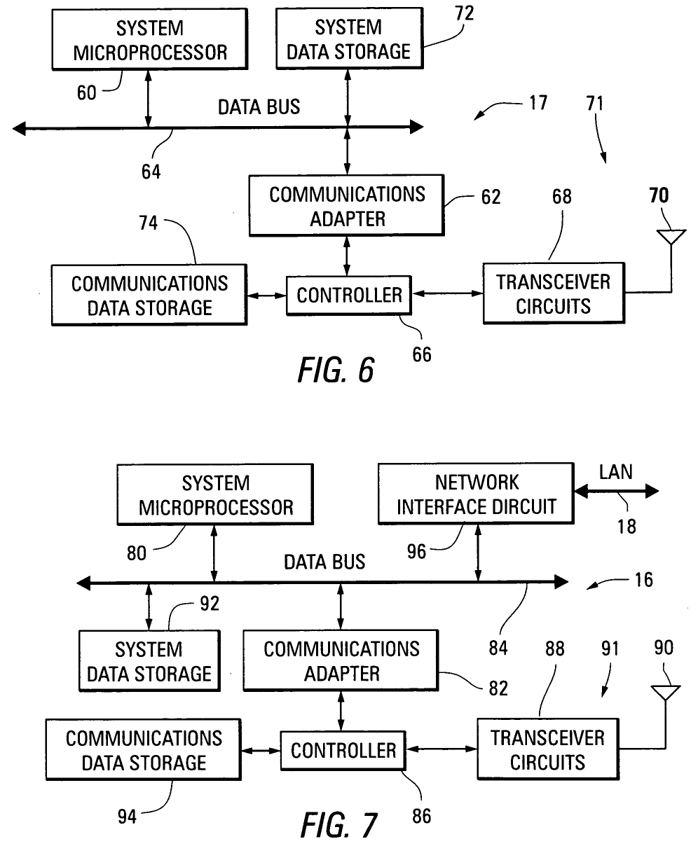

FIG. 6 is a block diagram of a wide-channel wireless device 17, which includes a system microprocessor 60 operating with a communications adapter circuit 62 through a connecting data bus 64. The communications adapter circuit 62 is in turn connected to a controller 66 that controls operation of transceiver circuits 68, which operate to transmit and receive wireless signals over an antenna 70, forming a transceiver 71. Data and instruction storage is provided within system storage 72 and additionally within communications storage 74. Both the system microprocessor 60 and the controller 66, or either of these wireless devices 60, 66, represent processor means for executing the instructions of a subroutine in accordance with the invention. Instructions for such a subroutine are stored within a machine readable medium formed within the system storage 72 and the communications storage 74, and may be provided in the form of a computer data signal transmitted through the transceiver 71. The wireless device 17 is considered to be a a wide-channel wireless device because its transceiver 71 receives and transmits a wide-channel wireless signal, such as a 40-MHz wide signal in accordance with 802.11n standards. The transceiver 71 may additionally transmit a narrow-channel signal, such as a 22 MHz wide signal in accordance with 802.11b or 802.11g standards to allow narrow-channel communications where a wide-channel access point cannot be found or to provide a capability needed for certain versions or embodiments of the invention.

FIG. 7 is an exemplary block diagram of the wide-channel access point 16, which includes a microprocessor 80 attached to a communications adapter 82 through a data bus 84. The communications adapter 82 is additionally connected to a controller 86, controlling operations within transceiver circuits 88, which transmit and receive data signals through an antenna 90, forming a transceiver 91. Both the system microprocessor 80 and the controller 86, or either of these wireless devices 80, 86, represent processor means for executing the instructions of a subroutine in accordance with the invention. Instructions for such a subroutine are stored within a machine readable medium formed within system storage 92 and the communications storage 94 and may be provided in the form of a computer data signal embodied on a carrier wave received by the transceiver circuit 91 or by the network interface circuit 96. The wide-channel access point 16 additionally includes a network interface circuit 96 transmitting and receiving data through the wired LAN 18. The access point 17 is considered to be a a wide-channel access point because its transceiver 91 because its transceiver 71 receives and transmits a wide-channel wireless signal, such as a 40-MHz wide signal in accordance with 802.11n standards.

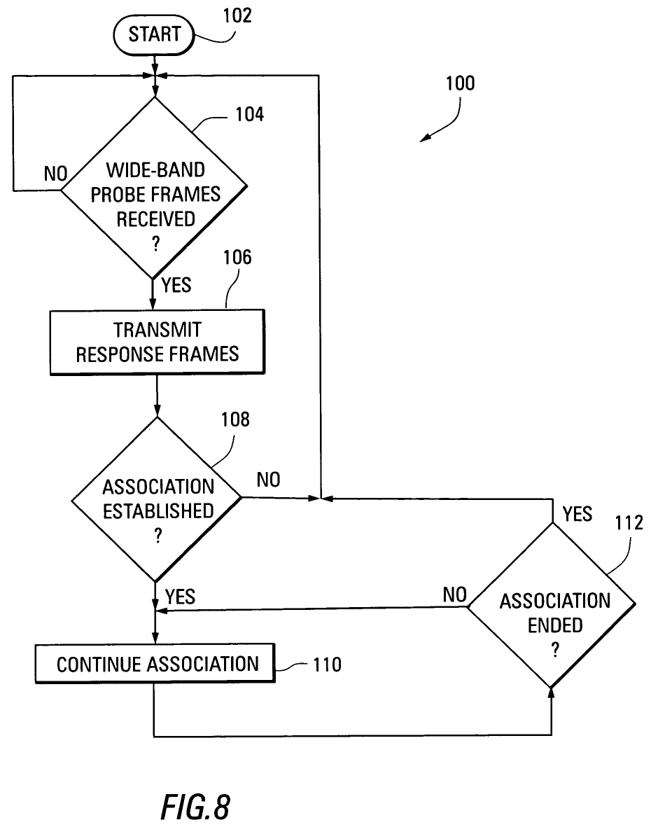

Various embodiments of the invention will now be discussed, with reference being made to FIGS. 8-13. In accordance with first and second embodiments of the invention, communications with the wide-channel access point 16 are begun in response to probe frames transmitted from a wide-channel wireless device 17. In accordance with third and fourth embodiments of the invention, communications with the wide-channel access point 16 are begun in response to a request transmitted from the wide-channel wireless device 17 to one of the narrow-channel access points 14 and from the narrow-channel access point 14 to the wide-channel access point 16 over the LAN 18. In accordance with the first and third embodiments, each communication using a wide-channel channel between a wide-channel wireless device 17 and the wide-channel access point 14 is started in the same way. In accordance with the second and fourth embodiments, when communications over a wide-channel channel, the wide-channel access point 16 transmits beacon frames to provide for communications with additional wide-channel wireless devices 17

The prove frames transmitted by the wireless device 17 are considered to be wide-channel probe frames in that they are encoded to elicit a response related to the establishment of wide-channel communications. They may be transmitted using a wide-channel signal or using a narrow-channel signal, with an encoded pattern describing that wide-channel communication is desired.

FIG. 8 is a flow chart showing steps within a subroutine 100 executing in processor means within the wide-channel access point 16 in accordance with the first embodiment of the invention. After starting in step 102, this subroutine 100 proceeds to step 104, in which the wide-channel access point 16 operates in a listening mode to determine whether wide-access probe frames, transmitted from a wide-channel wireless device 17, can be received within range of the access point 16. If such probe frames are not received, the subroutine 100 returns to step 104 to continue operation in the listening mode. If such probe frames are detected, the wide-channel access point 16 transmits response frames in step 106 to be received by the wireless device 17 generating the probe frames received in step 104.

Before communications can occur between the wide-channel wireless device 17 and the LAN 18 through the wide-channel access point 16, the wireless device 17 must be associated with the access point 16. For example, the access point 16 provides an authentication service, so that association is provided only to certain wireless devices 17, and with each wireless device 17 being identified by its MAC address. If it is determined in step 108 that the wireless device 17 has been associated with the access point 16, the association is continued in step 110, with a periodic determination being made in step 112 of whether the association has ended. For example, the association is ended if the wireless device 17 is moved out of range of the access point 16 or if the wireless device 16 is turned off. If it is determined in step 112 that the association has ended, or if it is determined in step 108 that the association has not been established, the subroutine 60 returns to step 104 to listen for wide-channel probe frames again.

Since the wide-channel access point 16 can communicate with a number of wide-channel wireless devices 17 at a time, the various steps of the subroutine 100 may be performed with a number of different wireless devices in a multitasking mode, with wide-channel communications occurring with the access point 16 until an association with each of the wireless devices 17 is ended.

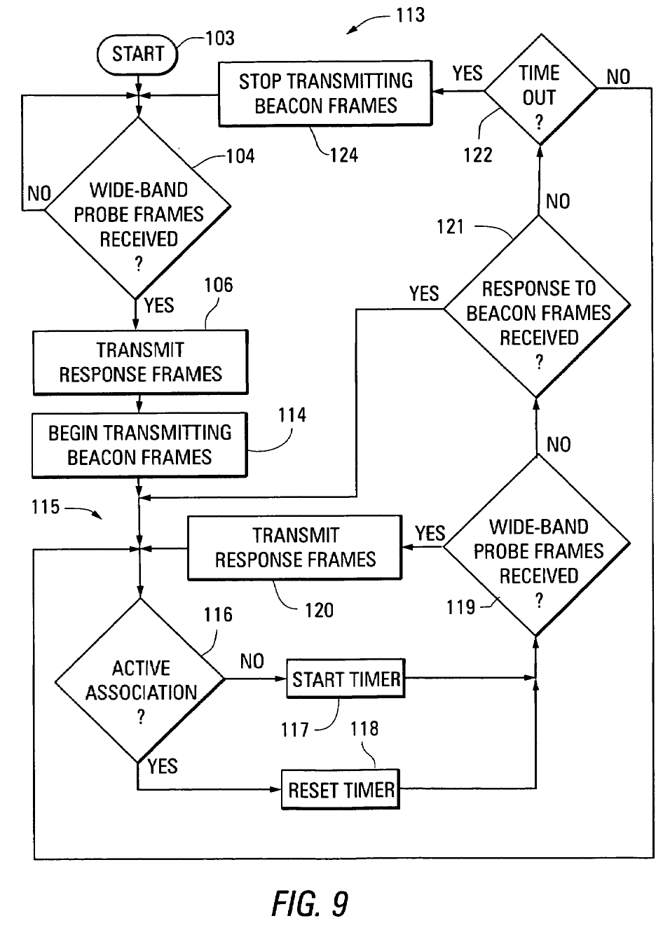

FIG. 9 is a flow chart showing processes occurring within the wide band access point 16 during the execution of a subroutine 113 therein, in accordance with the second embodiment of the invention. This subroutine 113 is similar in many ways to the subroutine 120 discussed above in reference to FIG. 8, with similar or identical process steps being accorded like reference numbers and with the following discussion particularly describing the differences between the subroutines 100, 113.

In the subroutine 113, when the presence of a wide-channel wireless device 17 is detected in step 104 by receiving wide-channel probe frames, the wide-channel access point 16 additionally begins transmitting wide-channel beacon frames in step 114, so that these wide-channel beacon frames may be received by other wide-channel wireless devices 17 needing to establish wide-channel communications. Then, a process 115 is started to determine whether an association has been made with one or more wide-channel wireless devices 17 and to provide a predetermined time duration for the response of such wide-channel wireless devices 17 which may be in range of the wide-channel access point 16. Within this process 115, a determination is made in step 116 of whether an association with a wide band wireless device 17 is active. Such an association is active if it has been established and if it has not yet ended. If no such association is active, a timer is started in step 117 to provide the predetermined time for response by a wide-channel access wireless device 17. For example, such a timer may be implemented using a circuit counting clock pulses. If it is determined that there is an active association with one or more wide-channel wireless devices 17, the timer is reset to an initial value in step 118, so that the timer will not run until is started again in step 117. Then, in step 119, a determination is made of whether wide-channel probe frames have been received. If they have, a response to these proved frames is transmitted in step 120, with the subroutine 113 then returning to step 116 to determine if there is one or more active associations. If such probe frames are not received, a further determination is made in step 121 of whether a response to the beacon frames, which have been transmitted since step 114 has been received. If such a response has been received, the subroutine 113 also returns to step 116. If such a response has not been received, a further determination is made in step 122 of whether a time-out condition, established by the timer set in step 117, has been reached. If it has not, the subroutine 113 returns to step 116 to continue the process 115. If this time out condition has been reached, the transmission of beacon frames is stopped in step 124, with the subroutine 113 then returning to step 104 to listen for wide-channel probe frames without interfering with communications occurring between narrow-channel wireless devices 15 and the narrow-channel access points 16.

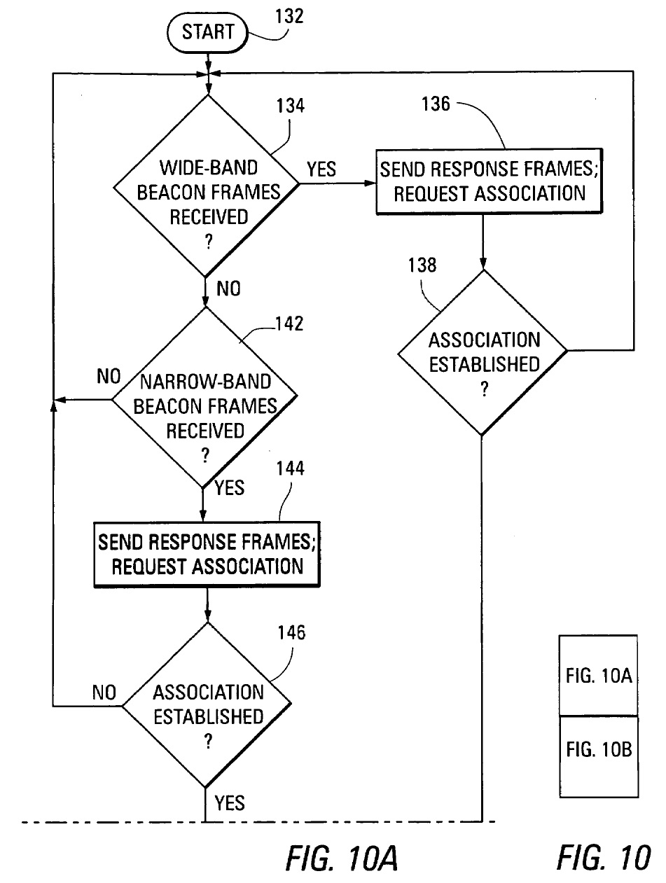

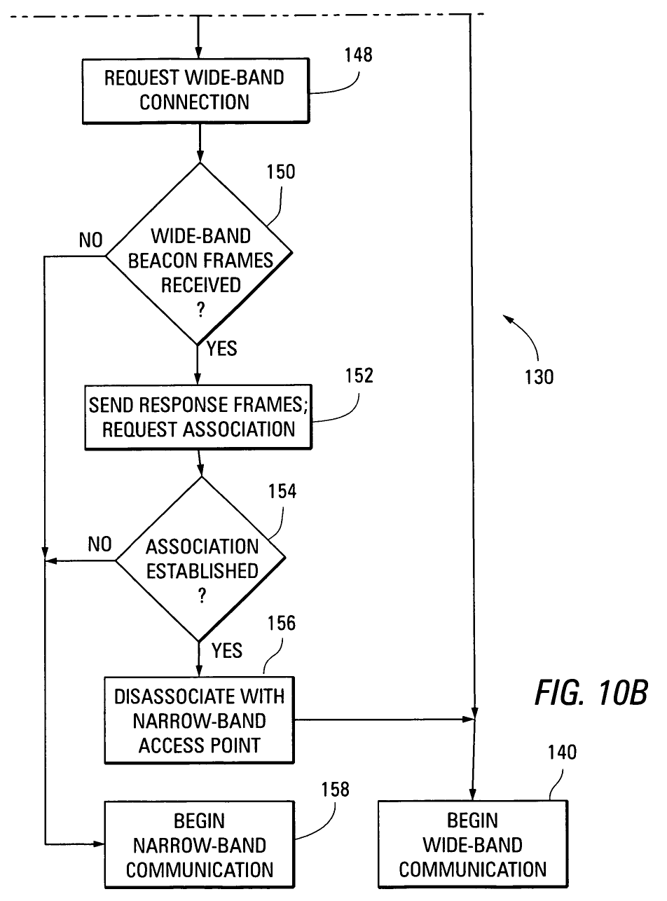

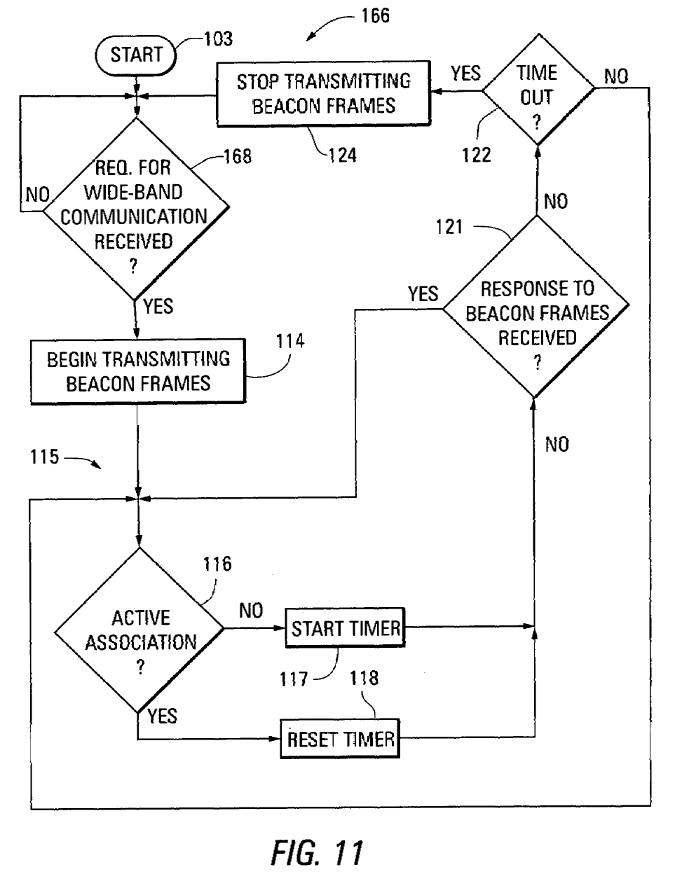

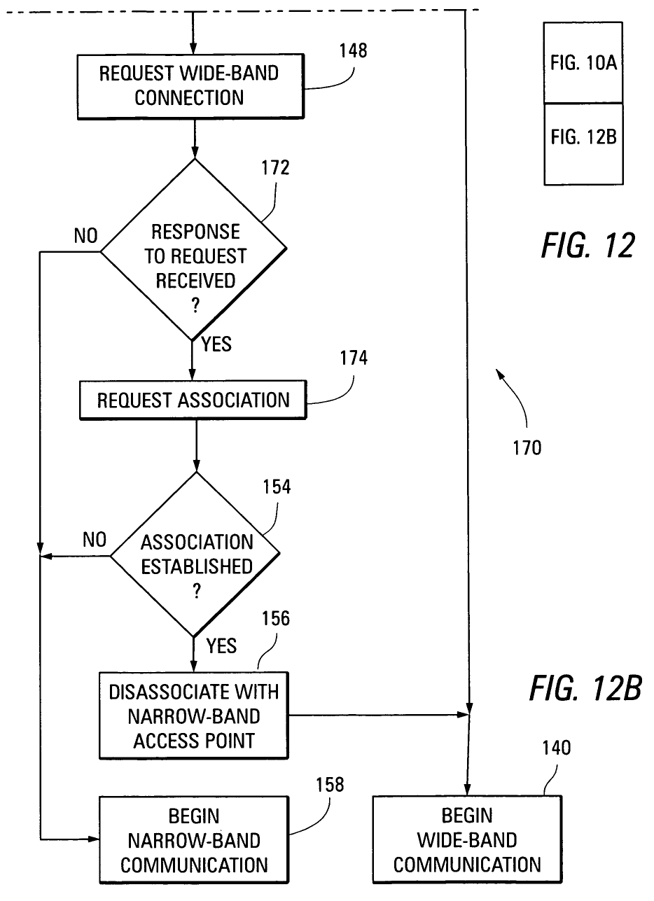

FIG. 10 is a flow chart, including an upper portion, indicated as FIG. 10A, and a lower portion, indicated as FIG. 10B, showing processes occurring within a wide-channel wireless device 17 during execution of a subroutine 130 in accordance with the third embodiment of the invention. Such a wide-channel wireless device 17 is provided with a capability for recognizing the presence of a wide-channel access point 16 by receiving wide-channel beacon frames transmitted by the access point 17 and additionally with a capability to establish communications with a wide-channel access point 16 that is not transmitting beacon frames by first associating with a narrow-channel access point 14 communicating with the wide band access point 16 through the LAN 18.

After starting in step 132, the subroutine 130 proceeds to step 134, in which is is determined whether wide-channel beacon frames are being received. If they are, response frames requesting association with a wide-channel access point are transmitted in step 136. If it is then determined in step 138 that such an association has been established, wide-channel communications through the access point 16 are begun in step 140. If it is determined in step 138 that the association has not been established, the subroutine 130 returns to step 134.

If it is determined in step 134 that wide-channel beacon frames are not being received, a further determination is made in step 142 of whether narrow-channel beacon frames are being received. If they are, a response to the narrow-channel beacon frames is sent in step 144, requesting association with the narrow-channel access point 14. If it is then determined in step 146 that such association has been granted, in step 148, a message requesting connection with a wide-channel access point 16. If a wide-channel access point 16 is available, being connected to the narrow-channel access point 14 by the LAN 18, the narrow-channel access point 14 transmits the message from step 148 to the wide band access point 16, which then begins transmitting wide-channel beacon frames. If such beacon frames are determined in step 150 to be received by the wide-channel wireless device 17, a response to the beacon frames is sent in step 152. If it is then determined in step 154 that an association has been established with the wide-channel access point 16, the wide-channel wireless device 17 disassociates with the narrow-channel access point 14 in step 156 and begins wide-channel communication through the wide-channel access point 16 in step 140.

On the other hand, if it is determined in step 142 that narrow-channel beacon frames are not being received, or in step 146 that an association has not been established with a narrow-channel access point 14, the subroutine 130 returns to step 134 to resume the process of listening for wide-channel or narrow-channel beacon frames. If it is determined in step 150 that wide-channel beacon frames are not being received, or in step 154 that an association has not been established with a wide-channel access point 16, advantage is taken of the association that has been established with a narrow-channel access point 14, with narrow-channel communications beginning in step 158.

FIG. 11 is a flow chart showing processes occurring within the wide-channel access point 16 during execution of a subroutine 166 therein in accordance with the third embodiment of the invention. This subroutine 166 is similar in many ways to the subroutine 113 discussed above in reference to FIG. 9, with similar or identical process steps being accorded like reference numbers and with the following discussion particularly describing the differences between the subroutines 113, 166.

Specifically, the process of subroutine 166 is similar to the process of subroutine 113 except that, with subroutine 166, wide-angle probe frames are not used, with wide-channel communications instead being started in response to a receiving a request for wide-channel communication in step 168, with the request being transmitted over the LAN 18 by a narrow-channel access point 14 in response to step 148 of FIG. 10. The beacon frames, then transmitted during a period beginning in step 114 and ending in step 124, may elicit responses from the wide-channel wireless device 17 causing the message to be transmitted over the LAN 18 and by other wide-channel wireless devices 17 within range of the wide-channel access point 16.

FIG. 12 is a flow chart, including an upper portion, indicated as FIG. 10A, and a lower portion, indicated as FIG. 10B, showing process steps occurring as a subroutine 170 is executed within a wide-channel wireless device 16 in accordance with the fourth embodiment of the invention. This subroutine 170 is similar in many ways to the subroutine 166 discussed above in reference to FIG. 10, with similar or identical process steps being accorded like reference numbers and with FIG. 10A forming a portion of both FIGS. 10 and 12. The following discussion particularly describes the differences between the subroutines 166, 170.

Within the subroutine 170, an ability to react to wide-channel beacon frames, determined to have been received in step 134, is retained so that the wide-channel wireless device 16 can react to an access point producing such beacon frames in an area not including narrow-channel access points 14. However, wide-channel beacon frames are not transmitted by a wide-channel access point 16 operating in accordance with the fourth embodiment of the invention. Instead, the wide-channel access point 16 transmits a response to the request for wide-channel communication transmitted over the LAN 18 with a response that is also transmitted over the LAN 18, being returned to the wide-channel access point 17 from the narrow-channel access point 15 that transmitted the request. If it is determined in step 172 that such a response has been received, a further determination is made in step 154 of whether an association with the wide-channel access point 16 has been achieved. If it is determined in step 172 that this response to the request has not been received, the wide-channel wireless device 17 begins narrow-channel communication through the narrow-channel access point 14 in step 158.

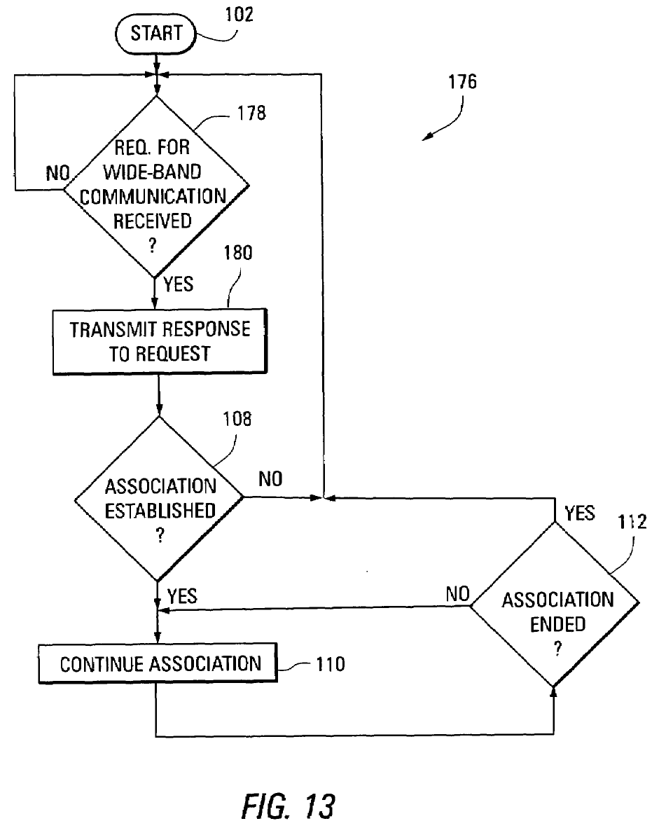

FIG. 13 is a flow chart showing processes occurring within the wide-channel access point 16 during execution of a subroutine 176 therein in accordance with the fourth embodiment of the invention. This subroutine 176 is similar in many ways to the subroutine 100 discussed above in reference to FIG. 8, with similar or identical process steps being accorded like reference numbers and with the following discussion particularly describing the differences between the subroutines 100, 176.

During the execution of the subroutine 176, the wide-channel access point 16 waits for a request for wide-channel communications to be received from the LAN 18. When a determination is made in step 178 that such a request has been received, a response is transmitted along the LAN 18 in step 180, with a further determination being made in step 108 of whether an association with a wide-channel wireless device 17 has occurred.

While the invention has been described in terms of its preferred embodiments in some degree of particularity, it is understood that this description has been provided only by way of an example, and that many variations can be made without departing from the spirit and scope of the invention, as described in the appended claims.

What is claimed is:

1. A method comprising:
determining whether at least one wide-channel wireless device is present within a common area;
establishing communications using a wide-channel wireless signal with at least one wide-channel wireless device in response to determining that at least one wide-channel wireless device is present within the common area;
determining that communications have ended with each wide-channel wireless device; and
stopping transmission of the wide-channel wireless signal in response to a determination that communications have ended with each wide-channel wireless device.

2. The method of claim 1, wherein
determining whether at least one wide-channel wireless device is present within the common area comprises determining whether wide-channel probe frames are being received from at least one wide-channel wireless device,
establishing communications using a wide-channel wireless signal with at least one wide-channel wireless device comprises transmitting wide-channel response frames in response to receiving the wide-channel probe frames, and
stopping transmission of the wide-channel wireless signal comprises stopping transmission of the wide-channel wireless signal without continuing to transmit wide-channel beacon frames.

3. The method of claim 1, wherein
determining whether at least one wide-channel wireless device is present within the common area comprises comprises determining whether wide-channel probe frames are being received from at least one wide-channel wireless device,
establishing communications using a wide-channel wireless signal with at least one wide-channel wireless device comprises transmitting wide-channel response frames in response to receiving the wide-channel probe frames, and beginning the transmission of wide-channel beacon frames, and
stopping transmission of the wide-channel wireless signal comprises determining that communications have ended with each wide-channel wireless device, for a predetermined period, determining that wide-channel probe frames are not being received, that a response to wide-channel beacon frames has not been received, and stopping transmission of the wide-channel beacon frames.

4. The method of claim 3, wherein establishing communications using a wide-channel wireless signal with at least one wide-channel wireless device additionally comprises establishing communications using a wide-channel wireless signal in response to receiving a response to the wide-channel beacon frames from a wide-channel wireless device.

5. The method of claim 1, wherein determining whether at least one wide-channel wireless device is present within the common area comprises comprises:
receiving a request for wide-channel communications within a narrow-channel access point, wherein the request for wide-channel communications is transmitted with a narrow-channel wireless signal; and
transmitting the request for wide-channel communications over a LAN from the narrow-channel access point to a wide-channel access point.

6. The method of claim 5, wherein establishing communications using a wide-channel wireless signal with at least one wide-channel wireless device comprises transmitting wide-channel beacon frames from the wide-channel access point in response to receiving the request for wide-channel communications transmitted over the LAN.

7. The method of claim 6, wherein stopping transmission of the wide-channel wireless signal comprises determining that communications have ended with each wide-channel wireless device, for a predetermined period, determining that a response to wide-channel beacon frames has not been received, and stopping transmission of the wide-channel beacon frames.

8. The method of claim 5, wherein establishing communications using a wide-channel wireless signal with at least one wide-channel wireless device comprises:
transmitting a response to the request for wide-channel communications over the LAN from the wide-channel access point to the narrow-channel access point; and
transmitting the response to the request for wide-channel communications using a narrow-channel wireless signal from the narrow-channel access point to the wide-channel wireless device.

9. An access point comprising:
a transceiver receiving and transmitting data using a wide-channel wireless signal;
a network interface circuit receiving and transmitting data over a LAN; and
a processor programmed to:
determine whether at least one wide-channel wireless device is present within range of the transceiver;
establish communications using the wide-channel wireless signal with at least one wide-channel wireless device in response to determining that at least one wide-channel wireless device is present within the common area;
determine that communications have ended with each wide-channel wireless device; and
stop transmission of the wide-channel wireless signal in response to a determination that communications have ended with each wide-channel wireless device.

10. The access point of claim 9, wherein
a determination of whether at least one wide-channel wireless device is present within range of the transceiver includes a determination of whether wide-channel probe frames are being received by the transceiver from at least one wide-channel wireless device,
communications using the wide-channel wireless signal with at least one wide-channel wireless device are established by transmission of wide-channel response frames in response to receiving the wide-channel probe frames, and
transmission of the wide-channel wireless signal is stopped without continuing to transmit wide-channel beacon frames.

11. The access point of claim 9, wherein
a determination of whether at least one wide-channel wireless device is present within range of the transceiver includes a determination of whether wide-channel probe frames are being received from at least one wide-channel wireless device,
communications using the wide-channel wireless signal with at least one wide-channel wireless device are established by transmission of wide-channel response frames in response to receiving the wide-channel probe frames, and beginning the transmission of wide-channel beacon frames, and
transmission of the wide-channel wireless signal, including transmission of the wide-channel beacon frames, is stopped in response to a determination that communications have ended with each wide-channel wireless device, that, for a predetermined period, wide-channel probe frames are not being received, and that a response to wide-channel beacon frames has not been received.

12. The access point of claim 11, wherein communications using the wide-channel wireless signal with at least one wide-channel wireless device are established in response to receiving a response to the wide-channel beacon frames from a wide-channel wireless device.

13. The access point of claim 9, wherein a determination of whether at least one wide-channel wireless device is present within range of the transceiver is made by receipt of a request for wide-channel wireless communication transmitted over the LAN.

14. The access point of claim 13, wherein communications using the wide-channel wireless signal with at least one wide-channel wireless device are established by transmission of wide band beacon frames using the wide-channel wireless signal in response to receipt of the request for wide-channel wireless communication transmitted over the LAN.

15. The access point of claim 14, wherein transmission of the wide-channel wireless signal, including transmission of the wide-channel beacon frames, is stopped in response to a determination that communications have ended with each wide-channel wireless device, and that, for a predetermined period, a response to wide-channel beacon frames has not been received.

16. The access point of claim 13, wherein communications using the wide-channel wireless signal with at least one wide-channel wireless device are established by the transmission of a response to the request for wide-channel communications over the LAN from the wide-channel access point to the narrow-channel access point;

17. A system for providing communications with narrow-channel wireless devices and with wide-channel wireless devices within a common area, wherein the system comprises:
a plurality of narrow-channel access points, wherein each of the narrow-channel access points establishes communications within the common area using a narrow-channel wireless signal at a different frequency;
a wide-channel access point establishing communications within the common area using a wide-channel wireless signal interfering with the wireless signals used by at least one of the narrow-channel access points, wherein the wide-channel access point includes a processor programmed to:
determine whether at least one wide-channel wireless device is present within range of the transceiver;
establish communications using the wide-channel wireless signal with at least one wide-channel wireless device in response to determining that at least one wide-channel wireless device is present within the common area;
determine that communications have ended with each wide-channel wireless device; and
stop transmission of the wide-channel wireless signal in response to a determination that communications have ended with each wide-channel wireless device; and
a LAN connecting the wide-channel access point with the plurality of narrow-channel access points.

18. The system of claim 17, wherein
a determination of whether at least one wide-channel wireless device is present within range of the transceiver comprises a determination of whether wide-channel probe frames are being received by the transceiver from at least one wide-channel wireless device,
communications are established using the wide-channel wireless signal with at least one wide-channel wireless device by a transmission of wide-channel response frames in response to receiving the wide-channel probe frames, and
transmission of the wide-channel wireless signal is stopped without continuing to transmit wide-channel beacon frames.

19. The system of claim 17, wherein
a determination of whether at least one wide-channel wireless device is present within range of the transceiver comprises determining whether wide-channel probe frames are being received from at least one wide-channel wireless device,
communications are established using the wide-channel wireless signal with at least one wide-channel wireless device by transmission of wide-channel response frames in response to receiving the wide-channel probe frames, and beginning the transmission of wide-channel beacon frames, and
transmission of the wide-channel wireless signal, including transmission of the wide-channel beacon frames, is stopped in response to a determination that communications have ended with each wide-channel wireless device, that, for a predetermined period, wide-channel probe frames are not being received, and that a response to wide-channel beacon frames has not been received.

20. The system of claim 19, wherein communications are established using the wide-channel wireless signal with at least one wide-channel wireless device by transmission of a wide-channel wireless signal in response to receiving a response to the wide-channel beacon frames from a wide-channel wireless device.

21. The system of claim 17, wherein
at least one of the narrow-channel access points is programmed to receive a message requesting wide-channel communications transmitted using a narrow-channel wireless signal and to transmit the message over the LAN to the wide-channel access point, and
a determination of whether at least one wide-channel wireless device is present within range of the transceiver comprises receipt of a request for wide-channel wireless communication transmitted over the LAN.

22. The system of claim 21, wherein communications are established using the wide-channel wireless signal with at least one wide-channel wireless device by transmission of wide band beacon frames using the wide-channel wireless signal in response to receipt of the request for wide-channel wireless communication transmitted over the LAN.

23. The system of claim 22, wherein transmission of the wide-channel wireless signal, including transmission of the wide-channel beacon frames, is stopped in response to a determination that communications have ended with each wide-channel wireless device, and that, for a predetermined period, a response to wide-channel beacon frames has not been received.

24. The system of claim 21, wherein
at least one of the narrow-channel access points is programmed to receive a response to the request transmitted over the LAN and to transmit the response using a narrow-channel wireless signal, and
communications are established using the wide-channel wireless signal with at least one wide-channel wireless device by transmission of a response to the request for wide-channel communications over the LAN from the wide-channel access point to the narrow-channel access point;

25. A wireless device comprising:
a transceiver receiving and transmitting data using a wide-channel wireless signal and a narrow-channel wireless signal; and
a processor programmed to transmit a request for wide-channel communications using the narrow-channel wireless signal.

26. The wireless device of claim 25, wherein
the request for wide-channel communications comprises probe frames, and
the processor is additionally programmed to receive a response to the probe frames, and to establish wide-channel wireless communications using the wide-channel wireless signal in response to receipt of the response to the probe frames.

27. The wireless device of claim 25, wherein the request for wide-channel communications is transmitted by establishment of an association with a narrow-channel access point and by transmission of a message requesting wide-channel communications to the narrow-channel access point.

28. The wireless device of claim 27, wherein the processor is additionally programmed to:
determine whether a response to the request for wide-channel communications has been received from the narrow-channel access point; and
establish wide-channel communications with a wide-channel access point in response to a determination that a response to the request has been received.

29. The wireless device of claim 28, wherein the processor is additionally programmed to establish narrow-channel communications with the narrow-channel access point in response to determining that a response to the request has not been received.

30. A machine readable medium containing machine usable code causing a processor within an access point to:
determine whether at least one wide-channel wireless device is present within range of the transceiver;
establish communications using the wide-channel wireless signal with at least one wide-channel wireless device in response to a determination that at least one wide-channel wireless device is present within the common area;
determine that communications have ended with each wide-channel wireless device; and
stop transmission of the wide-channel wireless signal in response to a determination that communications have ended with each wide-channel wireless device.

31. The machine readable medium of claim 30, wherein
a determination of whether at least one wide-channel wireless device is present within range of the transceiver includes a determination of whether wide-channel probe frames are being received by the transceiver from at least one wide-channel wireless device,
communications are established using the wide-channel wireless signal with at least one wide-channel wireless device by transmission of wide-channel response frames in response to receipt of the wide-channel probe frames, and
transmission of the wide-channel wireless signal is stopped without continuing to transmit wide-channel beacon frames.

32. The machine readable medium of claim 30, wherein
a determination of whether at least one wide-channel wireless device is present within range of the transceiver comprises a determination of whether wide-channel probe frames are being received from at least one wide-channel wireless device,
communications are established using the wide-channel wireless signal with at least one wide-channel wireless device comprises transmitting wide-channel response frames in response to receiving the wide-channel probe frames, and beginning the transmission of wide-channel beacon frames, and
transmission of the wide-channel wireless signal, including transmission of the wide-channel beacon frames is stopped in response to a determination that communications have ended with each wide-channel wireless device, that, for a predetermined period, wide-channel probe frames are not being received, and that a response to wide-channel beacon frames has not been received.

33. The machine readable medium of claim 32, wherein communications using the wide-channel wireless signal with at least one wide-channel wireless are established using a wide-channel wireless signal in response to receipt of a response to the wide-channel beacon frames from a wide-channel wireless device.

34. The machine readable medium of claim 30, wherein a determination of whether at least one wide-channel wireless device is present within range of the transceiver includes receipt of a request for wide-channel wireless communication transmitted over the LAN.

35. The machine readable medium of claim 34, wherein communications using the wide-channel wireless signal with at least one wide-channel wireless device are established by transmission of wide band beacon frames using the wide-channel wireless signal in response to receipt of the request for wide-channel wireless communication transmitted over the LAN.

36. The machine readable medium of claim 35, wherein transmission of the wide-channel wireless signal, including transmission of the wide-channel beacon frames, is stopped by determining that communications have ended with each wide-channel wireless device, and that, for a predetermined period, a response to wide-channel beacon frames has not been received.

37. The machine readable medium of claim 34, wherein communications using the wide-channel wireless signal with at least one wide-channel wireless device are established by transmission of a response to the request for wide-channel communications over the LAN from the wide-channel access point to the narrow-channel access point.

38. A machine readable medium containing machine usable code causing a processor within a wireless device to transmit a request for wide-channel communications using the narrow-channel wireless signal.

39. The machine readable medium of claim 38, wherein
the request for wide-channel communications is transmitted by a transmission of probe frames, and
the processor is additionally programmed to receive a response to the probe frames, and to establish wide-channel wireless communications using the wide-channel wireless signal in response to receiving the response to the probe frames.

40. The machine readable medium of claim 38, wherein transmission of the request for wide-channel communications comprises establishment of an association with a narrow-channel access point and transmission of a message requesting wide-channel communications to the narrow-channel access point.

41. The machine readable medium of claim 40, wherein the processor is additionally programmed to:
determine whether a response to the request for wide-channel communications has been received from the narrow-channel access point; and
establish wide-channel communications with a wide-channel access point in response to a determination that a response to the request has been received.

42. The machine readable medium of claim 41, wherein the processor is additionally programmed to establish narrow-channel communications with the narrow-channel access point in response to a determination that a response to the request has not been received.

43. A data signal embodied in a carrier wave containing machine usable code causing a processor within an access point to:
determine whether at least one wide-channel wireless device is present within range of the transceiver;
establish communications using the wide-channel wireless signal with at least one wide-channel wireless device in response to a determination that at least one wide-channel wireless device is present within the common area;
determine that communications have ended with each wide-channel wireless device; and
stop transmission of the wide-channel wireless signal in response to a determination that communications have ended with each wide-channel wireless device.

44. The data signal of claim 43, wherein
a determination of whether at least one wide-channel wireless device is present within range of the transceiver includes a determination of whether wide-channel probe frames are being received by the transceiver from at least one wide-channel wireless device,
communications are established using the wide-channel wireless signal with at least one wide-channel wireless device by transmission of wide-channel response frames in response to receipt of the wide-channel probe frames, and
transmission of the wide-channel wireless signal is stopped without continuing to transmit wide-channel beacon frames.

45. The data signal of claim 43, wherein
a determination of whether at least one wide-channel wireless device is present within range of the transceiver comprises a determination of whether wide-channel probe frames are being received from at least one wide-channel wireless device,
communications are established using the wide-channel wireless signal with at least one wide-channel wireless device comprises transmitting wide-channel response frames in response to receiving the wide-channel probe frames, and beginning the transmission of wide-channel beacon frames, and
transmission of the wide-channel wireless signal, including transmission of the wide-channel beacon frames is stopped in response to a determination that communications have ended with each wide-channel wireless device, that, for a predetermined period, wide-channel probe frames are not being received, and that a response to wide-channel beacon frames has not been received.

46. The data signal of claim 45, wherein communications using the wide-channel wireless signal with at least one wide-channel wireless are established using a wide-channel wireless signal in response to receipt of a response to the wide-channel beacon frames from a wide-channel wireless device.

47. The data signal of claim 43, wherein a determination of whether at least one wide-channel wireless device is present within range of the transceiver includes receipt of a request for wide-channel wireless communication transmitted over the LAN.

48. The data signal of claim 47, wherein communications using the wide-channel wireless signal with at least one wide-channel wireless device are established by transmission of wide band beacon frames using the wide-channel wireless signal in response to receipt of the request for wide-channel wireless communication transmitted over the LAN.

49. The data signal of claim 48, wherein transmission of the wide-channel wireless signal, including transmission of the wide-channel beacon frames, is stopped by determining that communications have ended with each wide-channel wireless device, and that, for a predetermined period, a response to wide-channel beacon frames has not been received.

50. The data signal of claim 47, wherein communications using the wide-channel wireless signal with at least one wide-channel wireless device are established by transmission of a response to the request for wide-channel communications over the LAN from the wide-channel access point to the narrow-channel access point.

51. A data signal embodied in a carrier wave containing machine usable code causing a processor within a wireless device to transmit a request for wide-channel communications using the narrow-channel wireless signal.

52. The data signal of claim 51, wherein
the request for wide-channel communications is transmitted by a transmission of probe frames, and
the processor is additionally programmed to receive a response to the probe frames, and to establish wide-channel wireless communications using the wide-channel wireless signal in response to receiving the response to the probe frames.

53. The data signal of claim 51, wherein transmission of the request for wide-channel communications comprises establishment of an association with a narrow-channel access point and transmission of a message requesting wide-channel communications to the narrow-channel access point.

54. The data signal of claim 53, wherein the processor is additionally programmed to:
determine whether a response to the request for wide-channel communications has been received from the narrow-channel access point; and
establish wide-channel communications with a wide-channel access point in response to a determination that a response to the request has been received.

55. The data signal of claim 54, wherein the processor is additionally programmed to establish narrow-channel communications with the narrow-channel access point in response to a determination that a response to the request has not been received.
